(19) United States
(12) Patent Application Publication
(10) Pub. No.: US 2026/0332382 A1
(43) Pub. Date: Oct. 22, 2026

(54) TRANSACTION SUPPORT SYSTEM, TRANSACTION SUPPORT METHOD, AND TRANSACTION SUPPORT PROGRAM

(71) Applicant: DWANGO Co., Ltd., Tokyo (JP)

(72) Inventors: Shota FUKUOKA, Tokyo (JP); Miki BANDO, Tokyo (JP); Shunya ARIGA, Tokyo (JP); Yasuo TANAKA, Tokyo (JP)

(73) Assignee: DWANGO Co., Ltd., Tokyo (JP)

(21) Appl. No.: 18/994,810

(22) PCT Filed: Sep. 4, 2023
(86) PCT No.: PCT/JP2023/032238

§ 371 Date: Jan. 15, 2025

(30) Foreign Application Priority Data
Sep. 30, 2022 (JP) 2022-158619
Sep. 30, 2022 (JP) 2022-158627
Sep. 30, 2022 (JP) 2022-158643

(51) Int. Cl. G06Q 40/04

(52) U.S. Cl. CPC H04L 9/00

(57) ABSTRACT

A transaction support system according to one aspect of the present disclosure includes at least one processor. The at least one processor receives an issuance operation by a creator of content, acquires a handwritten electronic signature of the creator input in the issuance operation, and issues an NFT to which the handwritten electronic signature is assigned. The NFT and the handwritten electronic signature have a one-to-one correspondence.

### TECHNICAL FIELD

One aspect of the present disclosure relates to a transaction support system, a transaction support method, and a transaction support program.

### BACKGROUND ART

A mechanism for trading digital content is known. For example, Patent Document 1 describes a system that manages ownership by associating a tangible real card with a digital card of electronic data. Patent Document 2 describes a system that displays a name of an owner of content.

### CITATION LIST

### Patent Documents

Patent Document 1: Japanese Patent Application Laid-Open No. 2022-079884

Patent Document 2: Japanese U.S. Pat. No. 7,058,898

### SUMMARY OF INVENTION

### Technical Problem

There is a need for a mechanism to support creators of content.

### Solution to Problem

A transaction support system according to one aspect of the present disclosure includes at least one processor. The at least one processor is configured to receive an issuance operation by a creator of content, acquire a handwritten electronic signature of the creator input in the issuance operation, and issue an NFT to which the handwritten electronic signature is assigned. The NFT and the handwritten electronic signature have a one-to-one correspondence.

In such an aspect, there is a one-to-one correspondence between the NFT and the handwritten electronic signature of the creator. This ensures the value of the NFT. This will provide an incentive for people who want to support creators to trade NFTs, thereby encouraging more trading activity. Demand for such NFTs and trading of such NFTs can support improvement of the popularity of the creators themselves. As a result, an environment can be provided to support creators of content.

### Advantageous Effects of Invention

According to one aspect of the present disclosure, it is possible to provide an environment for supporting creators of content.

### BRIEF DESCRIPTION OF DRAWINGS

FIG. 1 is a schematic diagram illustrating an example of a transaction in a transaction support system.

FIG. 2 is a diagram illustrating an example of an application of a transaction support system.

FIG. 3 is a diagram illustrating an example of a hardware configuration related to the transaction support system.

FIG. 4 is a diagram illustrating an example of a functional configuration related to the transaction support system.

FIG. 5 is a sequence diagram illustrating an example of an operation of the transaction support system.

FIG. 6 is a diagram illustrating an example of a display of a master NFT.

FIG. 7 is a sequence diagram illustrating another example of the operation of the transaction support system.

FIG. 8 is a sequence diagram illustrating still another example of the operation of the transaction support system.

### DESCRIPTION OF EMBODIMENTS

Hereinafter, embodiments of the present disclosure will be described in detail with reference to the accompanying drawings. In the description of the drawings, the same or equivalent elements are given the same reference numerals, and duplicate descriptions are omitted.

### System Overview

A transaction support system according to an embodiment is a computer system that supports content creators. Content refers to human-perceivable information provided by a computer or computer system. The expression format of the content is not limited, and the content may be expressed by an image (for example, a photograph, a video, and the like). The content may be provided, for example, by on-demand distribution or live distribution (live broadcast). A creator is a person or organization that creates various activities as content. Examples of activities include singing, dancing, musical performance, illustrations, games (operation or commentary), and the like. As an example, a creator creates a moving image of singing as creators of content.

The transaction support system issues, as non-fungible tokens (NFTs), a first NFT and a second NFT. The first NFT and the second NFT are the subject of trading, such as on a known electronic commerce platform (hereinafter referred to as a “marketplace”) or in buying and selling between individuals. The first NFT and the second NFT are electronic data displayable on a display device, for example, digital trading cards. Hereinafter, the first NFT will be referred to as a “master NFT” and the second NFT will be referred to as a “commemorative NFT.”

Master NFTs are issued for creators. For example, a master NFT is issued for any information about a creator (hereinafter referred to as a “label”). Examples of labels include activities, jobs, tags, fields, and keywords but are not limited thereto. In one example, a master NFT is issued for the activity of a creator. “For the activity of a creator” is a concept that includes the activity of a creator to create past content and future content, rather than individual content itself. The master NFT issued for the activity can trace the activity of a creator. For example, a master NFT allows access to a list of content (for example, a playlist) corresponding to a specific activity on a channel where a specific creator distributes content (a creator distribution channel). A master NFT can be issued a plurality of times for the same label. A handwritten electronic signature of the creator is assigned to the master NFT. The master NFT and the handwritten electronic signature have a one-to-one correspondence. In other words, the handwritten electronic signature is unique to each master NFT.

A commemorative NFT is issued in association with a master NFT for a creator or content. For example, a commemorative NFT is issued for a creator targeted by a master NFT in a case where the activity of the creator satisfies a predetermined condition. The commemorative NFT is distributed to an owner of the master NFT. The master NFT and the commemorative NFT can be bought and sold independently of each other.

The owners of the master NFTs can support the activities of creators by purchasing master NFTs and can look forward to acquiring future commemorative NFTs in return for their support. Therefore, it can be said that a master NFT is a certificate of a partnership between the creator and the owner of the master NFT. Hereinafter, the owner of the master NFT will be referred to as a “partner”.

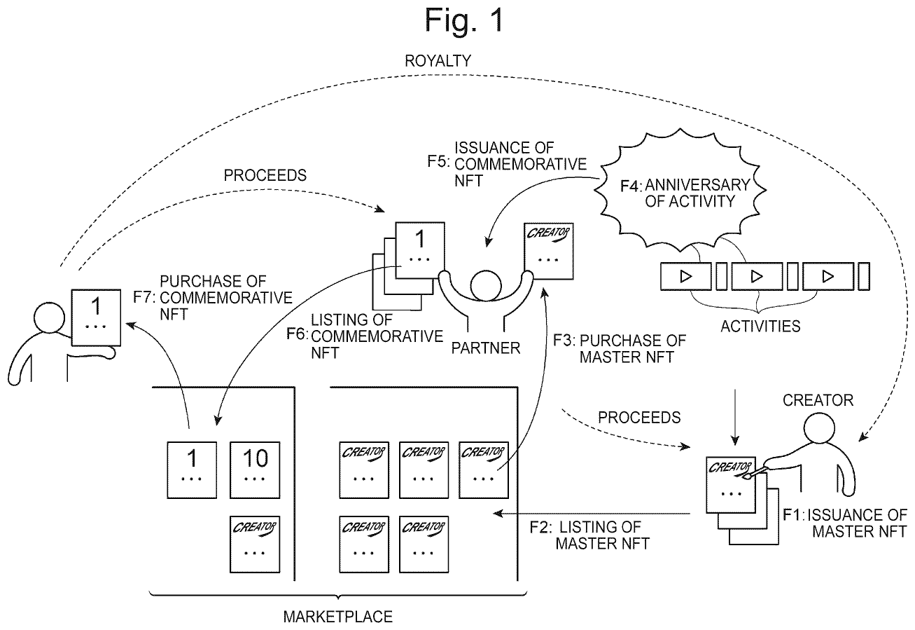

FIG. 1 is a schematic diagram illustrating an example of a transaction in a transaction support system. In process F1, a master NFT to which a handwritten electronic signature of a creator is assigned is issued. In process F2, the creator lists the master NFT on the marketplace. In process F3, a third party other than the creator purchases the master NFT. Anyone who purchases a master NFT becomes a partner. Creators receive a predetermined percentage of the proceeds from the buying and selling of master NFTs. In processes F1 to F3, after a third party purchases a pre-issuance master NFT, an actual token for that master NFT may be issued.

In process F4, the activities of the creator satisfy a predetermined condition. As an example, in a case where a creator creates a moving image of singing as content, the condition that the number of times the content has been played is equal to or greater than a predetermined number of times is satisfied. Such a milestone can be said to be an anniversary of an activity. In process F5, a commemorative NFT is issued and the commemorative NFT is distributed to the partner.

In process F6, the partner lists the commemorative NFT on the marketplace. In process F7, a third party other than the creator and partner purchases the commemorative NFT. Partners receive a predetermined percentage of the proceeds from the buying and selling of commemorative NFTs. Creators receive a predetermined royalty on the buying and selling of commemorative NFTs.

In a transaction such as that illustrated in FIG. 1, as the popularity of a creator is improved, the popularity of the master NFT and commemorative NFT is also improved. Accordingly, there is a likelihood that the transaction price, the number of times the transactions has executed, and the like of the master NFT and the commemorative NFT may also increase.

### System Configuration

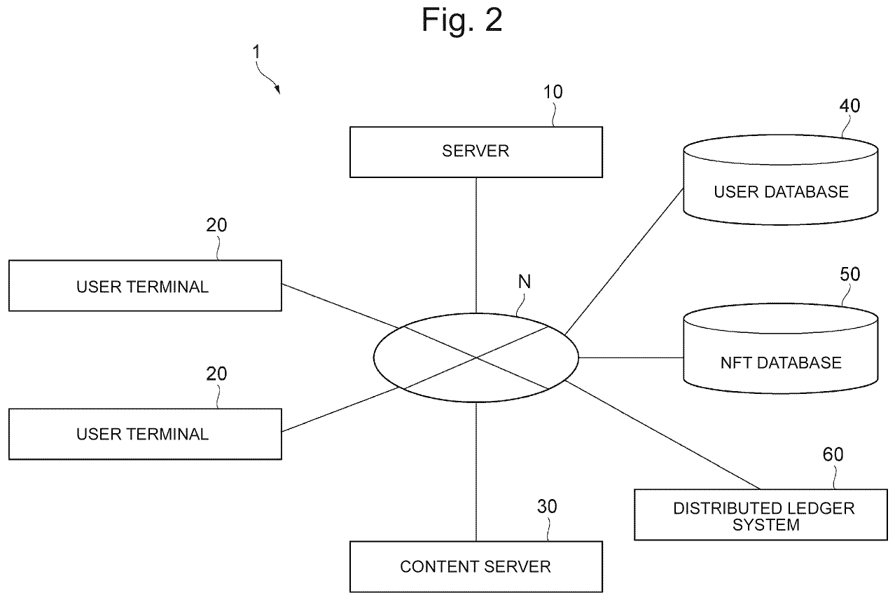

FIG. 2 is a diagram illustrating an example of an application of a transaction support system 1. In the present embodiment, the transaction support system 1 includes a server 10 (a transaction support server). The server 10 is a computer that manages the issuance of master NFTs and commemorative NFTs. The server 10 is connected to a plurality of user terminals 20, a content server 30, a user database 40, an NFT database 50, and a distributed ledger system 60 via a network N. The configuration of the network N is not limited. For example, the network N may include the Internet or include an intranet.

The user terminal 20 is a computer used by one or more users. A user is a person who uses the transaction support system 1. Examples of users include creators, personnel in charge of the company that operates the server 10, and the like. The type of the user terminal 20 is not limited. For example, the user terminal 20 may be a mobile terminal such as a high-function mobile phone (smartphone), a tablet terminal, a wearable terminal (for example, a head-mounted display (HMD), smart glasses, and the like), a laptop personal computer, or a mobile phone. Alternatively, the user terminal 20 may be a stationary terminal such as a desktop personal computer. The number of user terminals 20 is not limited.

The content server 30 is a computer that manages the content created by creators. The content in the present embodiment is a moving image. The content server 30 provides a website that distributes, for example, moving images. For example, the content server 30 provides a distribution channel or the like for content for each creator. The content server 30 manages images of the master NFTs and the commemorative NFTs.

The user database 40 is a non-transitory storage medium or storage device that stores information about users. The user database 40 stores attribute information of users (for example, creators). The attribute information is various types of information about the user, and may include, for example, an identifier, an age, and a gender of a user, and a level of a creator. A level of a creator is determined based on a degree of activity of the creator. For example, a level of a creator may be determined based on the number of times the content has been played (the number of times the content has been viewed), the period of activity, the number of followers of the creator, the number of subscribers to the distribution channel of the content, the number of comments on the content, and the like, or the level may be determined based on other information. A higher level of a creator may indicate more active activity. The user database 40 may be constructed as a single database, or may be a set of a plurality of databases. The location where the user database 40 is installed is not limited. For example, the user database 40 may be provided in a computer system separate from the transaction support system 1.

The NFT database 50 is a non-transitory storage medium or storage device that stores metadata for the master NFT and the commemorative NFT. Examples of metadata include a title, a description, a uniform resource identifier (URI) of the image, and the like. The title is a character string indicating the name of the master NFT or the name of the commemorative NFT, or the like, and is displayed, for example, in the marketplace. The description is a character string that describes the master NFT or the commemorative NFT, or that indicates a description of the content, or the like. The URI of the image is information for referring to, for example, an image of a master NFT or an image of a commemorative NFT managed by the content server 30. The NFT database 50 may be constructed as a single database, or may be a set of a plurality of databases. The location where the NFT database 50 is installed is not limited. For example, the NFT database 50 may be provided in a computer system separate from the transaction support system 1. The NFT database 50 may be configured using an interplanetary file system (IPFS).

The distributed ledger system 60 is a computer system that issues master NFTs and commemorative NFTs. The distributed ledger system 60 manages the distributed ledger using a blockchain. The distributed ledger system 60 is constructed using, for example, Ethereum. The distributed ledger system 60 issues master NFTs and commemorative NFTs that comply with the Ethereum Request for Comments 721 (ERC-721) standard. The issued master NFTs and commemorative NFTs will be recorded on the blockchain. Users who buy and sell master NFTs and commemorative NFTs acquire accounts on the distributed ledger system 60. For example, the creator has a contract address in the distributed ledger system 60. A uniquely identifiable token ID is allocated to each NFT issued on the distributed ledger system 60. The token ID is associated with a contract address of an issuer (for example, a creator).

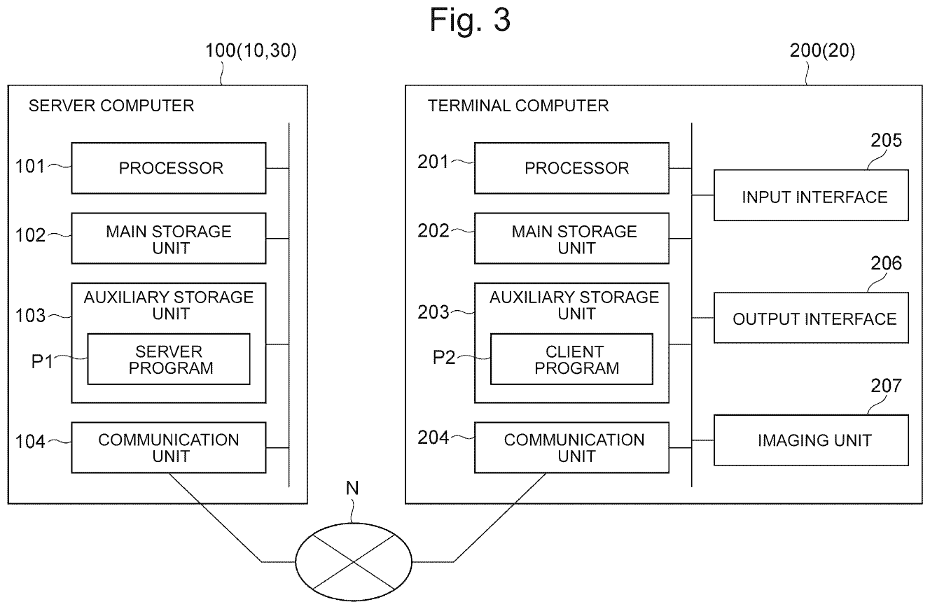

FIG. 3 is a diagram illustrating an example of a hardware configuration related to the transaction support system 1. FIG. 3 illustrates a server computer 100 functioning as the server 10 or the content server 30, and a terminal computer 200 functioning as the user terminal 20.

As an example, the server computer 100 includes, as hardware components, a processor 101, a main storage unit 102, an auxiliary storage unit 103, and a communication unit 104. The processor 101 is a computing device that executes an operating system and application programs, and is, for example, a central processing unit (CPU) or a graphics processing unit (GPU). The main storage unit 102 is a device that stores programs to be executed, computation results, and the like, and is configured with, for example, a read-only memory (ROM) or a random-access memory (RAM). The auxiliary storage unit 103 is generally a device capable of storing a larger amount of data than the main storage unit 102, and is configured with, for example, a non-volatile storage medium such as a hard disk or a flash memory. The auxiliary storage unit 103 stores a server program P1 for causing the server computer 100 to function as the server 10, and various types of data. The communication unit 104 is a device that executes data communication with other computers via the network N, and is configured with, for example, a network card or a wireless communication module.

In the present embodiment, a transaction support program is implemented as the server program P1. Each functional element of the server 10 is realized by loading the server program P1 onto the processor 101 or the main storage unit 102 and causing the processor 101 to execute the program. The server program P1 includes code for realizing each functional element of the server 10. The processor 101 operates the communication unit 104 in accordance with the server program P1, and executes reading and writing of data in the main storage unit 102 or the auxiliary storage unit 103.

The server 10 may be configured with one or more computers. In a case where a plurality of computers are used, these computers are connected to each other via a network N to logically configure one server 10.

As an example, the terminal computer 200 includes, as hardware components, a processor 201, a main storage unit 202, an auxiliary storage unit 203, a communication unit 204, an input interface 205, an output interface 206, and an imaging unit 207. The processor 201 is a computing device that executes an operating system and application programs, and is, for example, a CPU or a GPU. The main storage unit 202 is a device that stores programs to be executed, computation results, and the like, and is configured with, for example, a ROM or a RAM. The auxiliary storage unit 203 is generally a device capable of storing a larger amount of data than the main storage unit 202, and is configured with, for example, a non-volatile storage medium such as a hard disk or a flash memory. The auxiliary storage unit 203 stores a client program P2 for causing the terminal computer 200 to function as the user terminal 20, and various types of data. The communication unit 204 is a device that executes data communication with other computers via the network N, and is configured with, for example, a network card or a wireless communication module. The input interface 205 is a device that receives data based on a user's operation or action, and is configured with at least one of a keyboard, operation buttons, a pointing device, a touch panel, a microphone, a sensor, and a camera, for example. The output interface 206 is a device that outputs data processed by the terminal computer 200, and includes a display device such as a monitor, a touch panel, or an HMD. The imaging unit 207 is a device that captures an image (video or photograph) of the real world, such as a camera. The imaging unit 207 can also function as the input interface 205.

Each functional element of the user terminal 20 is realized by loading a corresponding client program P2 into the processor 201 or the main storage unit 202 and causing the processor 201 to execute the program. The client program P2 includes code for realizing each functional element of the user terminal 20. The processor 201 operates the communication unit 204, the input interface 205, the output interface 206, or the imaging unit 207 in accordance with the client program P2, and reads and writes data from and to the main storage unit 202 or the auxiliary storage unit 203.

At least one of the server program P1 and the client program P2 may be provided in a state in which it is non-temporarily recorded on a tangible recording medium such as a CD-ROM, a DVD-ROM, or a semiconductor memory. Alternatively, at least one of these programs may be provided via the network N as a data signal superimposed on a carrier wave. These programs may be provided separately or together.

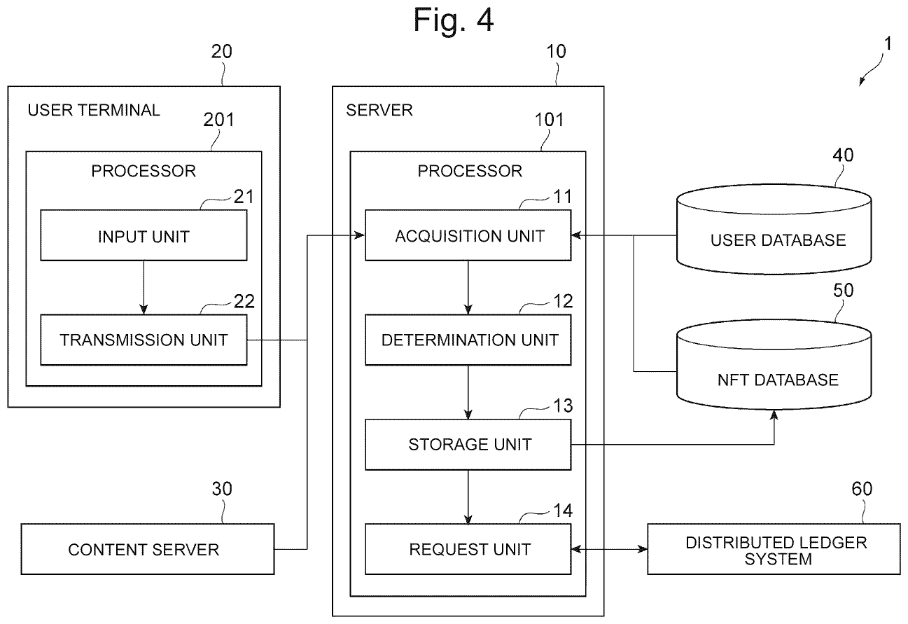

FIG. 4 is a diagram illustrating an example of a functional configuration related to the transaction support system 1. The server 10 includes, as functional elements, an acquisition unit 11, a determination unit 12, a storage unit 13, and a request unit 14. The acquisition unit 11 is a functional element that acquires information for generating a master NFT and a commemorative NFT. The determination unit 12 is a functional element that determines whether or not issuance conditions of a master NFT and a commemorative NFT are satisfied. The storage unit 13 is a functional element that stores metadata of the master NFT and the commemorative NFT in the NFT database 50. The request unit 14 is a functional element that requests the distributed ledger system 60 to issue a master NFT and a commemorative NFT.

The user terminal 20 includes an input unit 21 and a transmission unit 22 as functional elements. The input unit 21 is a functional element that receives an input of information about the master NFT. The transmission unit 22 is a functional element that transmits information about the master NFT to the server 10.

### System Operation

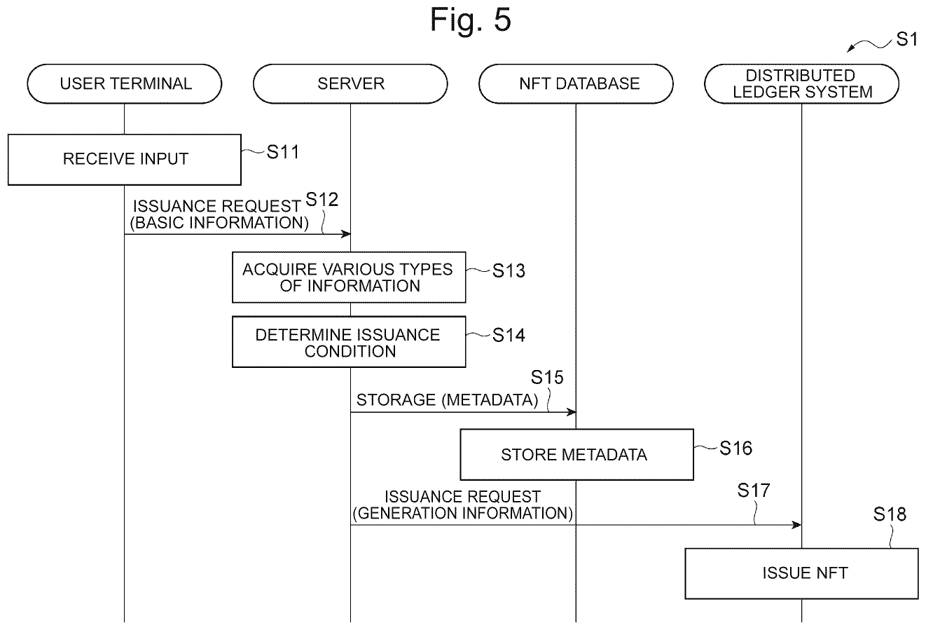

The operation of the transaction support system 1 will be described with reference to FIG. 5, and an example of a transaction support method will be described. FIG. 5 is a sequence diagram illustrating the operation of the transaction support system 1 as process flow S1. Process flow S1 shows the process for issuing a master NFT. In process flow S1, the user terminal 20 is operated by a creator.

In step S11, the input unit 21 of the user terminal 20 receives an issuance operation that triggers the issuance of a master NFT. The input unit 21 receives an input of basic information that designates various types of information for generating a master NFT. Examples of basic information include the design such as color, label, price of the master NFT, a handwritten electronic signature, and the like. The basic information may include an icon, which is an automatically acquired image indicating the creator, a thumbnail image of the moving image, which is the content, and the like. The input unit 21 receives an input of information designating, for example, a label. The label may be selected from a plurality of candidates. For example, the input unit 21 may receive a selection from candidates related to an activity, a job, a tag, or the like. In one example, the input unit 21 may receive a selection from modifiers (keywords) and job candidates. In this case, the label may be a character string that concatenates the modifier and the job.

A handwritten electronic signature is, for example, a handwritten character of the name of a creator. The input format of the handwritten electronic signature may be any input format that retains the creator's handwriting or idiosyncrasies. For example, a handwritten electronic signature can be input using a signature format with a tablet terminal and a touch pen, a mouse operation, a finger tracing operation, or the like. The input unit 21 may repeatedly receive an input of a handwritten electronic signature in correspondence with the desired number of issuances. As an example, in a case where the desired number of issuances is three, the input unit 21 may receive the input of a handwritten electronic signature three times. The desired number of issuances may be the number of times of the input operation of the basic information.

In step S12, the transmission unit 22 of the user terminal 20 transmits a request to issue a master NFT to the server 10. The issuance request may include the basic information input in step S11.

In step S13, the acquisition unit 11 of the server 10 acquires various types of information for generating the master NFT. For example, the acquisition unit 11 acquires basic information included in the request received from the user terminal 20. The acquisition unit 11 acquires the level of the creator associated with the user's identifier from the user database 40.

At this stage, the master NFT may be listed on the marketplace. In this description, it is assumed that a third party purchases a master NFT listed on the marketplace. The acquisition unit 11 may acquire various types of information about the partner who is the purchaser of the master NFT from the marketplace, the user terminal 20, or the like. The acquisition unit 11 may generate an image of the master NFT based on the basic information and transmit the image to the content server 30.

In step S14, the determination unit 12 of the server 10 determines whether or not the issuance conditions of the master NFT are satisfied. Examples of issuance conditions of the master NFT include whether or not the desired number of issuances exceeds an upper limit on the number of issuances of master NFTs. The upper limit on the number of issuances of master NFTs may be determined based on the level of the creator. For example, the upper limit on the number of issuances of master NFTs may be determined to be higher, the higher the level of the creator. In this description, it is assumed that the desired number of issuances is within an upper limit. In this way, the determination unit 12 limits the number of issuances of master NFTs to an upper limit based on the level.

In step S15, the storage unit 13 of the server 10 stores the metadata of the master NFT in the NFT database 50. The metadata of the master NFT includes a title, a description, a URI of the image, and the like. The title is generated based on, for example, the name of the creator, the label, and the type of NFT. The type of NFT here is information indicating a master NFT. As an example, the title is generated by concatenating a character string of the name of the creator, the label, and the type of NFT.

In step S16, the NFT database 50 stores the metadata of the master NFT based on the request received from the server 10.

In step S17, the request unit 14 of the server 10 transmits a request to issue a master NFT to the distributed ledger system 60. The request may include generation information for the master NFT. Examples of generation information for the master NFT include a contract address of the creator, an address of the partner, a URI of metadata of the master NFT, a handwritten electronic signature, and the like. The address of the partner here is the address of an account on the distributed ledger system 60. The URI of metadata of the master NFT is information for referring to the metadata of the master NFT stored in the NFT database 50.

In step S18, the distributed ledger system 60 issues the master NFT based on the request received from the server 10. A handwritten electronic signature is assigned to the master NFT. The master NFT is associated with a URI of metadata of the master NFT. The URI of the image is recorded in the metadata of the master NFT. Therefore, the master NFT can trace the URI of the image through the URI of the metadata of the master NFT.

The owner of the master NFT is managed by the distributed ledger system 60. Specifically, the owner of the master NFT is recorded on the blockchain. The owner of the master NFT will be issued as a partner. When a master NFT is bought or sold, the owner of the master NFT is transferred. At the time of buying and selling, the token ID of the contract address of the creator is associated with the address of the partner.

The server 10 and the content server 30 may store information about the issued master NFT. For example, the server 10 and the content server 30 may synchronously or asynchronously store information such as the identifier of the master NFT, the owner of the master NFT, and the like. Alternatively, the server 10 and the content server 30 may acquire information about the master NFT from the distributed ledger system 60 as necessary. The server 10 and the content server 30 may store, for each creator, whether or not a master NFT has been issued.

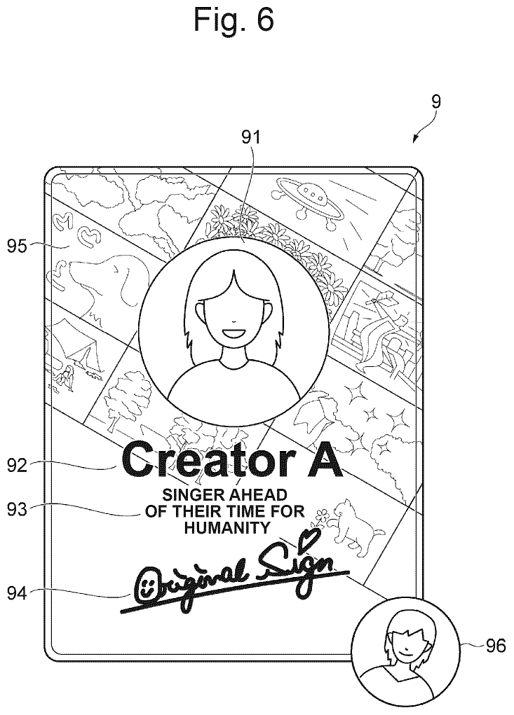

FIG. 6 is a diagram illustrating an example of a display of a master NFT 9 according to the embodiment. The master NFT 9 is displayed, for example, on a display device of a user terminal 20 used by the owner (partner) of the master NFT 9. The master NFT 9 includes, as screen elements, a creator icon 91, a creator name 92, a title 93, a handwritten electronic signature 94, a background 95, and a partner icon 96.

The creator icon 91 displays an image showing the creator. The image showing the creator is used, for example, on the creator distribution channel on the content server 30. “Creator A” is displayed as the creator name 92. The title 93 displays a label “A singer ahead of their time for humanity” configured with a modifier “ahead of their time for humanity” and a job “singer”. The title 93 is a character string that concatenates a modifier selected by the creator and a job. The creator name 92 may be displayed larger than the title 93. The creator is active using the name “Creator A” and, as an example, has the title “A singer ahead of their time for humanity”.

The handwritten electronic signature 94 displays the handwritten electronic signature assigned to the master NFT 9. The handwritten electronic signature displayed in the handwritten electronic signature 94 indicates that the signature is one that retains handwriting or idiosyncrasies.

In the background 95, an image showing the activities of the creator is displayed. For example, the background 95 is an image generated based on content created by a creator. As an example, the background 95 is generated based on a thumbnail image of a moving image, which is the content. The thumbnail images used for the background 95 may be a predetermined number of thumbnail images selected in order of most recently updated. The background 95 may be an illustration or the like instead of a thumbnail image as an image showing the activities of the creator. In another example, the background 95 is not limited to an image showing the activities of the creator, but may be, for example, a specified design, color, a combination thereof, or the like.

The partner icon 96 displays an image showing the partner. Information about the partner, including an image showing the partner, may be managed by the content server 30. On the master NFT 9, the creator icon 91 and the partner icon 96 are displayed simultaneously. This allows the master NFT 9 to visually express the partnership between creators and partners. The partner icon 96 does not have to be displayed.

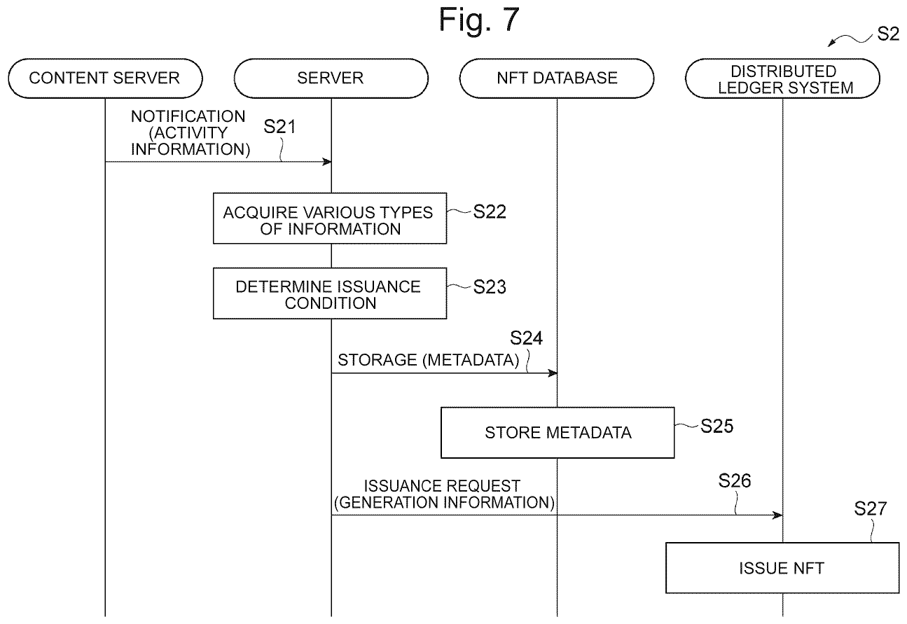

The operation of the transaction support system 1 will be described with reference to FIG. 7, and another example of the transaction support method will be described. FIG. 7 is a sequence diagram illustrating the operation of the transaction support system 1 as process flow S2. Process flow S2 shows the process for issuing a commemorative NFT.

In step S21, the content server 30 transmits activity information indicating the degree of activity of the creator to the server 10. Examples of activity information include the identifier of the master NFT, the number of times the content has been played, the period of activity, the number of followers of the creator, the number of subscribers to the distribution channel of the content, the number of comments on the content, and the like. For example, the content server 30 transmits, to the server 10, activity information about a specific activity of a specific creator for which a master NFT has been issued. The content server 30 may periodically transmit the activity information about the creator to the server 10, or may transmit the activity information about the creator to the server 10 with an anniversary of the activity of the creator or the like as a trigger.

In step S22, the acquisition unit 11 of the server 10 acquires various types of information for generating the commemorative NFT. For example, the acquisition unit 11 acquires activity information received from the content server 30.

In step S23, the determination unit 12 of the server 10 determines whether or not the issuance conditions of the commemorative NFT are satisfied. Examples of issuance conditions of a commemorative NFT include activity information indicated by quantity or period being equal to or greater than a predetermined threshold and the like. Examples of predetermined conditions include the number of times the content has been played, the period of activity, the number of followers of the creator, the number of subscribers to the distribution channel of the content, the number of comments on the content, and the like being equal to or greater than a corresponding predetermined threshold, and the like. As an example, the determination unit 12 may determine whether or not the number of times the content has been played is 10,000 or more. In this description, it is assumed that the activity information satisfies a predetermined condition.

In step S24, the storage unit 13 of the server 10 stores the metadata of the commemorative NFT in the NFT database 50. The metadata of the commemorative NFT includes a title, a description, a URI of the image, and the like. The title is generated based on, for example, the name of the creator, the label, and the type of NFT. The type of NFT here is information indicating a commemorative NFT.

In step S25, the NFT database 50 stores the metadata of the commemorative NFT based on the request received from the server 10.

In step S26, the request unit 14 of the server 10 requests the distributed ledger system 60 to issue a commemorative NFT. The request may include generation information for the commemorative NFT. Examples of generation information for the commemorative NFT include a contract address of the creator, an address of the partner, a URI of metadata of the commemorative NFT, a handwritten electronic signature, and the like. The URI of metadata of the commemorative NFT is information for referring to the metadata of the commemorative NFT stored in the NFT database 50. The request may include a contract for the buying and selling of the commemorative NFT. For example, the request may include a contract under which the creator receives royalties associated with buying and selling of the commemorative NFT.

In step S27, the distributed ledger system 60 issues the commemorative NFT based on the request received from the server 10. No handwritten electronic signature is assigned to the commemorative NFT. The commemorative NFT is associated with a URI of metadata of the commemorative NFT. The URI of the image is recorded in the metadata of the commemorative NFT. Therefore, the commemorative NFT can trace the URI of the image through the URI of the metadata of the commemorative NFT. The commemorative NFT may be assigned with a contract under which the creator receives royalties associated with the buying and selling of the commemorative NFT. This contract may be implemented, for example, by an Ethereum smart contract.

The owner of the commemorative NFT is managed by the distributed ledger system 60. Specifically, the owner of the commemorative NFT is recorded on the blockchain. In process flow S2, the owner of the initially issued commemorative NFT is the same as the owner of the master NFT. When a commemorative NFT is bought or sold, the owner of the commemorative NFT is transferred. At the time of buying and selling, the token ID of the contract address of the creator is associated with the address of the owner of the commemorative NFT.

In relation to step S21, the content server 30 may transmit the activity information about the creator to the server 10 in response to a request received from the server 10. For example, in response to a request to acquire activity information about a specific creator, the content server 30 may transmit activity information about the creator to the server 10. In relation to steps S21 and S22, the server 10 or the content server 30 may determine the level of the creator based on the activity information and store the level of the creator in the user database 40.

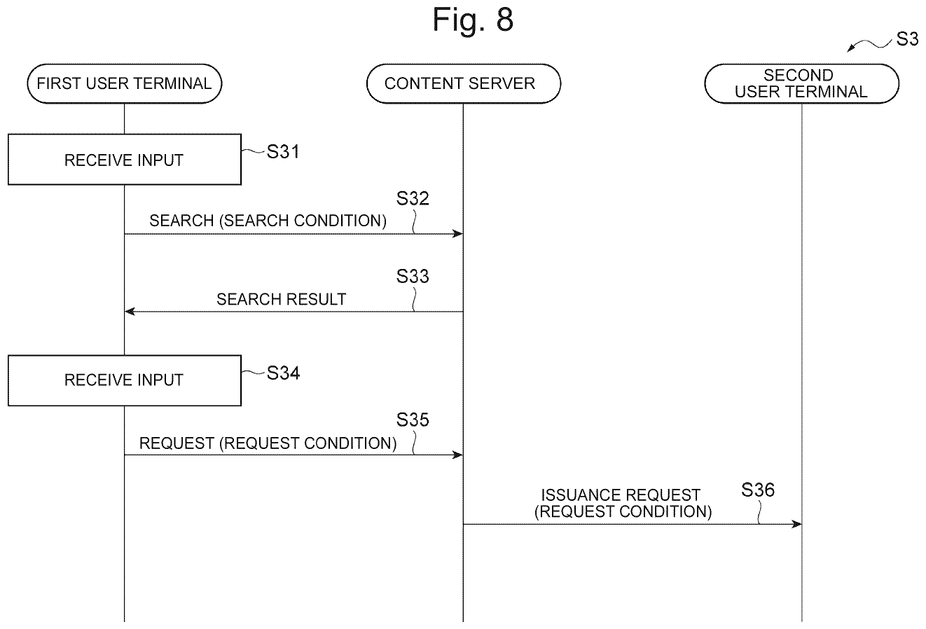

The operation of the transaction support system 1 will be described with reference to FIG. 8, and another example of the transaction support method will be described. FIG. 8 is a sequence diagram illustrating the operation of the transaction support system 1 as process flow S3. Process flow S3 is executed before process flow S1 and shows a process of requesting the issuance of a new master NFT. Hereinafter, the user terminal 20 of the user who wishes to purchase a master NFT will be referred to as a first user terminal, and the user terminal 20 of the creator will be referred to as a second user terminal.

In step S31, the first user terminal receives an input of search conditions for information about the master NFT. Examples of search conditions include a name and a label of the creator and the like, but the search condition is not limited thereto.

In step S32, the first user terminal transmits a search request to the content server 30. The search request may include search conditions.

In step S33, in response to the search request, the content server 30 transmits the search results to the first user terminal. The search results are displayed on the display device of the first user terminal. The search results may be, for example, information on whether or not a master NFT has been issued for a creator corresponding to the creator name designated in the search conditions. The search results are information indicating that no master NFTs have been issued here. Whether or not a master NFT has been issued may be managed by the content server 30 or may be acquired from the distributed ledger system 60.

In step S34, the first user terminal receives an input of desired request conditions regarding the issuance of a master NFT. The request conditions are conditions indicating what kind of master NFT is desired to be issued. Examples of request conditions include the name of the creator, the information about the label, the desired price for the master NFT, and the like.

In step S35, the first user terminal transmits a request to the content server 30. The request may include a request condition.

In step S36, the content server 30 transmits a request to the second user terminal. The request condition included in the request is displayed on the display device of the second user terminal.

Process flow S3 is executed after process flow S1 and may be a process of requesting the listing of a master NFT. For example, in process flow S3, the second user terminal may be the user terminal 20 of the owner of the master NFT. In relation to step S33, the search result may be information indicating that a master NFT has been issued. In relation to step S34, the first user terminal may receive an input of desired request conditions regarding the listing of the master NFT. Examples of request conditions include the name of the creator, the information for specifying the label, the desired price for the master NFT, and the like. In relation to steps S35 and S36, the request including the request condition is transmitted via the content server 30 to the second user terminal. In another example, steps S31 to S33 may be omitted.

### Effects

As described above, a transaction support system according to one aspect of the present disclosure includes at least one processor. The at least one processor receives an issuance operation by a creator of content, acquires a handwritten electronic signature of the creator input in the issuance operation, and issues an NFT to which the handwritten electronic signature is assigned. The NFT and the handwritten electronic signature have a one-to-one correspondence.

A transaction support method according to one aspect of the present disclosure is executed by a transaction support system including at least one processor. The transaction support method includes receiving an issuance operation by a creator of content, acquiring a handwritten electronic signature of the creator input in the issuance operation, and issuing an NFT to which the handwritten electronic signature is assigned. The NFT and the handwritten electronic signature have a one-to-one correspondence.

A transaction support program according to one aspect of the present disclosure causes a computer to execute receiving an issuance operation by a creator of content, acquiring a handwritten electronic signature of the creator input in the issuance operation, and issuing an NFT to which the handwritten electronic signature is assigned. The NFT and the handwritten electronic signature have a one-to-one correspondence.

In such an aspect, there is a one-to-one correspondence between the NFT and the handwritten electronic signature of the creator. This ensures the value of the NFT. This will provide an incentive for people who want to support creators to trade NFTs, thereby encouraging more trading activity. Demand for such NFTs and trading of such NFTs can support improvement of the popularity of the creators themselves. As a result, an environment can be provided to support creators of content.

A transaction support system according to one aspect of the present disclosure includes at least one processor. The at least one processor acquires information input by a creator of content that designates a label indicating information about the creator, and issues an NFT for the label.

A transaction support method according to one aspect of the present disclosure is executed by a transaction support system including at least one processor. The transaction support method includes acquiring information input by a creator of content that designates a label indicating information about the creator, and issuing an NFT for the label.

A transaction support program according to one aspect of the present disclosure causes a computer to execute acquiring information input by a creator of content that designates a label indicating information about the creator, and issuing an NFT for the label.

In such an aspect, the NFT is issued using a label indicating information about the creator. It will be made clear that NFTs will be issued for specific creators. This will make the purpose of trading clearer for people who wish to trade NFTs, thereby encouraging more trading activity. Demand for such NFTs and trading of such NFTs may encourage creator activity. As a result, an environment can be provided to support creators of content.

In the transaction support system, at least one processor may acquire a level determined based on the activity of the creator, determine an upper limit on the number of issuances of NFTs based on the level, and limit the number of issuances of NFTs to the upper limit. In other words, the number of issuances of NFTs is adjusted to the number of issuances matching the level. In other words, the upper limit on the number of issuances of NFTs will change in conjunction with the activities of the creator. This will provide an incentive for creators to raise the upper limit on the number of issuances.

In the transaction support system, at least one processor may transmit a request condition for issuing the NFT, including information about the label, to a terminal of the creator. When issuing the NFT, the request condition can be used as reference information, thereby improving convenience for creators.

A transaction support system according to one aspect of the present disclosure includes at least one processor. The at least one processor acquires activity information for a creator targeted by a first NFT, indicating a degree of activity of the creator, determines whether or not an issuance condition is satisfied based on the activity information and a predetermined threshold, and issues a second NFT in a case where the activity information satisfies the issuance condition. At the time of initial issuance of the second NFT, the owner of the first NFT and the owner of the second NFT are the same.

A transaction support method according to one aspect of the present disclosure is executed by a transaction support system including at least one processor. The transaction support method includes acquiring activity information for a creator targeted by a first NFT, indicating a degree of activity of the creator, determining whether or not an issuance condition is satisfied based on the activity information and a predetermined threshold, and issuing a second NFT in a case where the activity information satisfies the issuance condition. At the time of initial issuance of the second NFT, the owner of the first NFT and the owner of the second NFT are the same.

A transaction support program according to one aspect of the present disclosure causes a computer to execute acquiring activity information for a creator targeted by a first NFT, indicating a degree of activity of the creator, determining whether or not an issuance condition is satisfied based on the activity information and a predetermined threshold, and issuing a second NFT in a case where the activity information satisfies the issuance condition. At the time of initial issuance of the second NFT, the owner of the first NFT and the owner of the second NFT are the same.

In such an aspect, in a case where activity information of a creator who is a target of a first NFT satisfies a predetermined issuance condition, a second NFT is issued in association with the owner of the first NFT. That is, the owner of a first NFT can acquire a second NFT that is issued in accordance with the degree of activity of the creator. This will provide an incentive for people who wish to trade the first NFT to trade the first NFT, thereby encouraging more trading activity. Demand for such first NFTs and trading of such first NFTs may encourage creator activity. As a result, an environment can be provided to support creators of content.

In the transaction support system, at least one processor may assign, to the second NFT, a contract under which the creator receives royalties associated with buying and selling of the second NFT when issuing the second NFT. In this case, the buying and selling of the second NFTs will increase revenue opportunities for creators. Therefore, incentive is provided for creators to increase the degrees of activities of the creators in order to encourage the issuance of second NFTs.

In the transaction support system, the first NFT may be assigned with a handwritten electronic signature of the creator. At least one processor may issue the second NFT without assigning the handwritten electronic signature of the creator to the second NFT. In this case, the first NFT and the second NFT are differentiated by whether or not a handwritten electronic signature is assigned. For those wishing to trade a first NFT or a second NFT, the purpose of the transaction becomes clear. This allows transactions to be tailored to the needs of potential purchasers.

### Modification Examples

The embodiments of the present disclosure have been described above in detail. However, the present disclosure is not limited to the above embodiments. The present disclosure can be modified in various ways without departing from the gist of the present disclosure.

In the above embodiments, the server 10 and the user terminal 20 have been described as separate computers, but the server 10 and the user terminal 20 may be the same computer or the same computer system. In this case, creators and the like can directly access the distributed ledger system 60 and issue master NFTs and the like. In another example, the server 10, the content server 30, and the NFT database 50 may be the same computer or the same computer system. In this case, data management in the transaction support system 1 becomes easier.

In the present disclosure, the expression “at least one processor executes a first process, executes a second process, . . . executes an n-th process” or a corresponding expression is a concept including cases where the executing entity (that is, the processor) of the n processes from the first process to the n-th process changes along the way. That is, this expression is a concept that includes both the case where all of the n processes are executed by the same processor and the case where the processor is changed among the n processes according to any policy.

The processing procedures of the method executed by the at least one processor are not limited to the examples in the above embodiments. For example, some of the steps (processes) described above may be omitted, or each step may be executed in a different order. In addition, any two or more of the steps described above may be combined, or some of the steps may be modified or deleted. Alternatively, other steps may be executed in addition to the steps described above.

Any part or all of the functional units described in the present specification may be realized by a program. The program mentioned in the present specification may be distributed by being non-temporarily recorded on a computer-readable recording medium, or may be distributed via a communication line (including wireless communication) such as the Internet, or may be distributed in an installed state on any terminal.

Based on the above description, those skilled in the art may conceive additional effects or various modification examples of the present disclosure, but the aspects of the present disclosure are not limited to the specific embodiments described above. Various additions, modifications, and partial deletions are possible without departing from the conceptual idea and gist of the present disclosure derived from the contents defined in the claims and their equivalents.

For example, a configuration described in the present specification as a single device (or member; the same applies below) (including a configuration depicted in the drawings as a single device) may be realized by a plurality of devices. Alternatively, a configuration described in the present specification as a plurality of devices (including a configuration depicted in the drawings as a plurality of devices) may be realized by a single device. Alternatively, part or all of the means or functions included in a certain device (for example, a server) may be included in another device (for example, a user terminal).

Not all of the matters described in the present specification are essential requirements. For example, matters described in the present specification but not described in the claims may be considered optional additional matters.

The applicant is only aware of the known technologies described in the “Citation List” section of the present specification. It should also be noted that the present disclosure is not necessarily intended to solve any problems in the known technologies. The problem to be solved in the present disclosure should be recognized in light of the entire present specification. For example, in a case where it is stated in the present specification that a predetermined effect is achieved by a specific configuration, it can also be said that the problem corresponding to the predetermined effect is solved. However, the description of the effects does not necessarily imply that such a specific configuration is an essential requirement.

### Addenda

(1)

A transaction support system including at least one processor, wherein the at least one processor is configured to:
receive an issuance operation by a creator of content; acquire a handwritten electronic signature of the creator input in the issuance operation; and issue an NFT to which the handwritten electronic signature is assigned, and the NFT and the handwritten electronic signature have a one-to-one correspondence.
   (2)

A transaction support method executed by a transaction support system including at least one processor, the transaction support method including:
receiving an issuance operation by a creator of content;
acquiring a handwritten electronic signature of the creator input in the issuance operation; and
issuing an NFT to which the handwritten electronic signature is assigned, wherein the NFT and the handwritten electronic signature have a one-to-one correspondence.
   (3)

A transaction support program causing a computer to execute:
receiving an issuance operation by a creator of content;
acquiring a handwritten electronic signature of the creator input in the issuance operation; and
issuing an NFT to which the handwritten electronic signature is assigned, wherein the NFT and the handwritten electronic signature have a one-to-one correspondence.
   (4)

A transaction support system including:
at least one processor, wherein
the at least one processor is configured to:
   acquire information input by a creator of content that designates a label indicating information about the creator; and
   issue an NFT for the label.
      (5)

The transaction support system described in (4), wherein
the at least one processor is configured to:
   acquire a level determined based on an activity of the creator;
   determine an upper limit on the number of issuances of NFTs based on the level; and
   limit the number of issuances of NFTs to the upper limit.
      (6)

The transaction support system described in (4), wherein the at least one processor is configured to transmit a request condition for issuing the NFT, including information about the label, to a terminal of the creator.

(7)

A transaction support method executed by a transaction support system including at least one processor, the transaction support method including:
acquiring information input by a creator of content that designates a label indicating information about the creator; and
issuing an NFT for the label.
   (8)

A transaction support program causing a computer to execute:
acquiring information input by a creator of content that designates a label indicating information about the creator; and
issuing an NFT for the label.
   (9)

A transaction support system including:
at least one processor, wherein
the at least one processor is configured to:
   acquire activity information for a creator targeted by a first NFT, indicating a degree of activity of the creator;
   determine whether or not an issuance condition is satisfied based on the activity information and a predetermined threshold; and
   issue a second NFT in a case where the activity information satisfies the issuance condition, and
at the time of initial issuance of the second NFT, an owner of the first NFT and an owner of the second NFT are the same.
   (10)

The transaction support system described in (9), wherein
the first NFT is assigned with a handwritten electronic signature of the creator, and
the at least one processor is configured to issue the second NFT without assigning the handwritten electronic signature of the creator to the second NFT.
   (11)

A transaction support method executed by a transaction support system including at least one processor, the transaction support method including:
acquiring activity information for a creator targeted by a first NFT, indicating a degree of activity of the creator;
determining whether or not an issuance condition is satisfied based on the activity information and a predetermined threshold; and
issuing a second NFT in a case where the activity information satisfies the issuance condition, wherein
at the time of initial issuance of the second NFT, an owner of the first NFT and an owner of the second NFT are the same.
   (12)

A transaction support program causing a computer to execute:
acquiring activity information for a creator targeted by a first NFT, indicating a degree of activity of the creator;
determining whether or not an issuance condition is satisfied based on the activity information and a predetermined threshold; and
issuing a second NFT in a case where the activity information satisfies the issuance condition, wherein
at the time of initial issuance of the second NFT, an owner of the first NFT and an owner of the second NFT are the same.

### REFERENCE CHARACTERS

1: transaction support system
10: server
11: acquisition unit
12: determination unit
13: storage unit
14: request unit
20: user terminal
21: input unit
22: transmission unit
30: content server
40: user database
50: NFT database
60: distributed ledger system
N: network
P1: server program
P2: client program

1. A transaction support system, comprising:
at least one processor, wherein
the at least one processor is configured to:
receive an issuance operation by a creator of content;
acquire a handwritten electronic signature of the creator input in the issuance operation; and
issue an NFT to which the handwritten electronic signature is assigned, and the NFT and the handwritten electronic signature have a one-to-one correspondence.

2. A transaction support method executed by a transaction support system including at least one processor, the transaction support method comprising:
receiving an issuance operation by a creator of content;
acquiring a handwritten electronic signature of the creator input in the issuance operation; and
issuing an NFT to which the handwritten electronic signature is assigned, wherein
the NFT and the handwritten electronic signature have a one-to-one correspondence.

3. A non-transitory computer-readable medium storing thereon a transaction support program that, when executed, causes a computer to execute:
receiving an issuance operation by a creator of content;
acquiring a handwritten electronic signature of the creator input in the issuance operation; and
issuing an NFT to which the handwritten electronic signature is assigned, wherein
the NFT and the handwritten electronic signature have a one-to-one correspondence.
